(19) United States
(12) Patent Application Publication
(10) Pub. No.: US 2024/0118970 A1
(43) Pub. Date: Apr. 11, 2024

(54) TECHNIQUES FOR MEMORY SCRUBBING ASSOCIATED WITH RELIABILITY AVAILABILITY AND SERVICEABILITY FEATURES

(71) Applicant: Intel Corporation, Santa Clara, CA (US)

(72) Inventors: Ricardo SANDOVAL TORRES, Zapopan (MX); Jose De Jesus PEREZ SEVILLA, Guadalajara (MX); Jorge HERRERA FIGUEROA, Zapopan (MX)

(21) Appl. No.: 18/544,227

(22) Filed: Dec. 18, 2023

(51) Int. Cl. G06F 11/10; G06F 11/16

(52) U.S. Cl. CPC G06F 11/106; G06F 11/1068; G06F 11/1658

(57) ABSTRACT

Examples include techniques for memory scrubbing associated with reliability, availability and serviceability (RAS) features. Examples include obtaining error correction code (ECC) encoded data stored in a physical memory unit maintained in a physical memory device in associated with a memory scrubbing operation. Examples include correcting detected errors in ECC encoded data and cause the corrected or scrubbed ECC encoded data to be stored in the physical memory unit. Examples include obtaining the scrubbed ECC encoded data from the physical memory unit and responsive to at least one detected error in the scrubbed ECC encoded data, trigger one or more RAS features.

### TECHNICAL FIELD

Descriptions are generally related to techniques for memory scrubbing a memory device.

### BACKGROUND

In today's computing world, maintaining good computer system reliability and uptime is often important or even mandatory. To maintain significant computer uptime, system designers build reliability, availability, and serviceability, (RAS) features to improve overall system reliability and availability. Thus, it may be common to find various degrees of redundancy, error correction, error detection and error containment techniques employed at different levels in a system that deploys RAS features.

One common type of computer system failure can be attributed to system memory errors. Memory devices arranged to maintain system memory can be susceptible to errors such as transient (or soft) errors. Also, some types of system memory such as memory maintained on dual in-line memory modules (DIMMs) can be used for longer periods of time due to large investments in DIMMs in certain deployments such as in cloud and data centers. Longer periods of use of DIMMs can increase a system memory's susceptibility to errors. If errors such as transient errors are not handled properly, they can cause a computing system to malfunction.

When implementing RAS features, memory subsystems can receive a higher level of attention in order to detect, reduce and/or eliminate transient errors. For example, redundant information in the form of error correcting codes (ECCs) or other such error correction information can be used in association with memory scrubbing operations to improve overall system reliability. Demand memory scrubbing is one error detection/correction technique for which errors in a memory segment, whether single-bit or multi-bit errors, can be detected in scrubbing operation to service a host operating system's requests to access the memory segment. By contrast, another type of scrubbing operation known as patrol memory scrubbing pro-actively scans a memory segment for errors before, or otherwise independent of, any such host operating system requests to access the memory segment. For example, while the memory segment is in an idle operating state in which requests to access the memory segment are not expected to occur.

Another type of RAS feature—known as “memory sparing”—allocates one or more memory segments each to be available for service as a spare segment in the event of an actual or expected future failure of an in-use (or “active”) memory segment. When error detection or other mechanisms indicate such failure of an in-use memory segment, a spare memory segment is allocated to serve as a successor to (substitute for) the failed/failing segment. The system memory map is updated to associate addresses—e.g., a range of addresses—with memory locations of the successor memory segment, where previously such addresses were mapped to variously identify respective locations of the failed/failing active memory segment. A well-known sparing method to identify and fix failed/failing memory segments is described in the DDR5 standard (double data rate version 5, JESD79-5B_v 1.20, originally published by JEDEC (Joint Electronic Device Engineering Council) in September 2022). The DDR5 standard describes two types of post package repair (PPR) techniques. A first PPR technique can permanently remove failed/failing memory segment(s) from the system memory map and is known as hard PPR (hPPR). A second technique can temporarily (e.g., until the next power cycle) remove failed/failing memory from the system memory map and is known as soft PPR (sPPR).

### BRIEF DESCRIPTION OF THE DRAWINGS

FIG. 1 illustrates an example first system.

FIG. 2 illustrates example portions of the first system.

FIG. 3 illustrates an example first process.

FIG. 4 illustrates an example second process.

FIG. 5 illustrates an example scheme.

FIG. 6 illustrates an example apparatus.

FIG. 7 illustrates an example logic flow.

FIG. 8 illustrates an example medium.

FIG. 9 illustrates an example second system.

FIG. 10 illustrates an example device.

### DETAILED DESCRIPTION

Examples discussed herein variously provide for error detection in system memory that can include one or more spare memory segments. As used herein, “memory segment” can refer to a unit of memory maintained at a memory device such as a DIMM. In one or more respects, a memory segment can be operated independently of similar units of memory. A memory segment can include a bank or other type of unit of memory—e.g., wherein the unit of memory can include multiple, variously-addressable memory locations. A memory segment can include, or couple to, interface hardware that can be dedicated to coupling with that memory segment, and not one or more other memory segments, with a bus or other interconnect coupled between that memory segment and a memory controller. Alternatively or in addition, the memory segment can include a dedicated chip enable input, address decoder or other logic. Features of certain aspects of memory scrubbing associated with RAS features are discussed herein with respect to various implementations of memory scrubbing and/or memory sparing for individual memory segments. This disclosure can cover a variety of types of memory segments and/or units of memory to include, but not limited to, memory rows, sub-banks, or banks.

In some examples, a given memory segment can be classified as either active or spare—e.g., based on whether a host operating system (OS) or other agent is currently able to access that memory segment. A spare segment can be available for eventual activation to serve as either a temporary or permanent replacement for another memory segment. The other memory segment, for example, could have been identified as a failed memory segment. For brevity, such a memory segment can be referred to as “failed/failing.” Memory scrubbing operations can be variously performed according to different examples to detect—and in some examples, correct—errors in one or more memory segments. Examples are not limited with respect to the particular means by which ECCs or other such error correction information are variously calculated, stored and subsequently retrieved for use in performing an individual error detection calculation. The particular details of such means, which can be adapted from conventional error detection/correction techniques and mechanisms, are not discussed herein to avoid obscuring features of memory scrubbing associated with RAS as described in this disclosure.

According to some examples, scrubbing of a memory segment can be performed based on placeholder data (and corresponding error correction information) which, for example, circuitry of a memory controller and/or memory device can store in the memory segment—e.g., independent of a host OS or other requestor agent. During such scrubbing of the memory segment, the memory segment can be invisible to (for example, unregistered with) the host OS or other such requestor agent which has access to memory segments currently mapped to system memory.

In some examples, circuitry of a memory controller can be configured to perform memory error scrubbing of memory segments during idle time (e.g., while there are no transactions into those memory segments). In other words, perform a patrol memory scrubbing operation. This circuitry to perform memory error scrubbing can be referred to as “scrub circuitry”. For these examples, detected errors (if correctable) can be later corrected using ECC. Also, to finish a memory scrubbing operation, corrected or scrubbed data can be written back to at least one of the memory segments. However, this write transaction at the end of the memory scrubbing operation can be vulnerable to either transient errors or hardware/memory device errors. These transient errors or hardware/memory device errors of at least one memory segment after the write transaction can result in an intermittent scenario for which errors continue to be detected and ECC correction implemented over and over until an error threshold is met. Meeting the error threshold can then trigger other or additional RAS features such as, but not limited to, hPPR, sPPR, or resilvering data to other memory devices or memory segments. Implicit costs associated with this intermittent scenario such as implementing hPPR, sPPR, or resilvering RAS features once an error threshold is met or surpassed, which can take a relatively long period of time and can result in multiple memory scrubbing operations/cycles before deciding to implement the other or additional RAS features. Depending on operating conditions of a computing system, multiple interrupts can cause the computing system to enter into a system management mode (SMM) to correct detected errors and to implement the other or additional RAS features. Repeatedly entering the SMM can result in a memory bandwidth penalty.

As described in more detail below, memory scrubbing techniques can be implemented to identify hardware/memory device errors after a write transaction of a memory scrubbing operation, such as a patrol scrub, by performing an additional read of the scrubbed data. In some examples, if the additional read of the scrubbed data has detected errors, other RAS features such as sPPR can be triggered before an error threshold is met or surpassed for a given memory segment. Since a patrol scrub is typically executed during idle times, some or all of the memory bandwidth penalties associated with the above-mentioned intermittent scenario can be avoided.

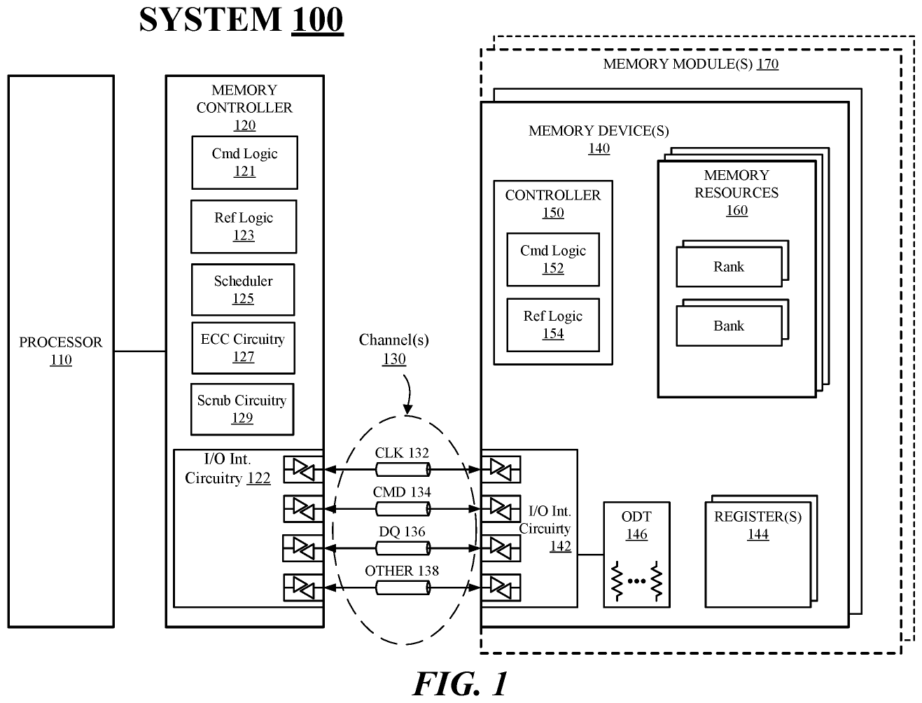

FIG. 1 illustrates an example system 100. In some examples, as shown in FIG. 1, system 100 includes a processor and elements of a memory subsystem in a computing device. Processor 110 represents a processing unit of a computing platform that can execute an operating system (OS) and applications, which can collectively be referred to as the host or the user of the memory subsystem. The OS and applications execute operations that result in memory accesses. Processor 110 can include one or more separate processors. Each separate processor can include a single processing unit, a multicore processing unit, or a combination. The processing unit may be a primary processor such as a central processing unit (CPU), a peripheral processor such as a graphics processing unit (GPU), or a combination. Memory accesses may also be initiated by devices such as a network controller or hard disk controller. Such devices can be integrated with the processor in some systems or attached to the processer via a bus (e.g., a PCI express bus), or a combination. System 100 can be implemented as a system on a chip (SOC) or can be implemented with standalone components.

Reference to memory devices may apply to different memory types. Memory devices can often include types of memory configured operate according to various volatile memory technologies. In addition to, or alternatively to, volatile memory, in some examples, reference to memory devices can also include types of memory configured to operate according to various nonvolatile memory technologies and whose state is determinate even if power is interrupted to the device. In one example, the nonvolatile memory device is a block addressable memory device, such as NAND or NOR technologies. A memory device may also include byte or block addressable types of non-volatile memory having a 3-dimensional (3-D) cross-point memory structure that includes, but is not limited to, chalcogenide phase change material (e.g., chalcogenide glass) hereinafter referred to as “3-D cross-point memory”. Non-volatile types of memory may also include other types of byte or block addressable non-volatile memory such as, but not limited to, multi-threshold level NAND flash memory, NOR flash memory, single or multi-level phase change memory (PCM), resistive memory, nanowire memory, ferroelectric transistor random access memory (FeTRAM), anti-ferroelectric memory, resistive memory including a metal oxide base, an oxygen vacancy base and a conductive bridge random access memory (CB-RAM), a spintronic magnetic junction memory, a magnetic tunneling junction (MTJ) memory, a domain wall (DW) and spin orbit transfer (SOT) memory, a thyristor based memory, a magnetoresistive random access memory (MRAM) that incorporates memristor technology, spin transfer torque MRAM (STT-MRAM), or a combination of any of the above.

Descriptions herein referring to a random access memory (RAM) or RAM device can apply to any memory device that allows random access, whether volatile or nonvolatile. Descriptions referring to a dynamic RAM (DRAM), synchronous DRAM (SDRAM), DRAM device or SDRAM device can refer to a volatile random access memory device. The memory device, SDRAM or DRAM may refer to the die itself, to a packaged memory product that includes one or more dies, or both. In some examples, a system with volatile memory that needs to be refreshed may also include at least some nonvolatile memory. As described herein, reference to memory devices can apply to different memory types. Memory devices can refer to volatile memory technologies. Volatile memory is memory whose state (and therefore the data stored on it) is indeterminate if power is interrupted to the device. Nonvolatile memory refers to memory whose state is determinate even if power is interrupted to the device. Dynamic volatile memory requires refreshing the data stored in the device to maintain state. One example of dynamic volatile memory includes DRAM, or some variant such SDRAM. A memory subsystem as described herein can be compatible with a number of memory technologies or standards, such as DDR3 (DDR version 3), JESD79-3F, originally released by JEDEC in July 2012, DDR4 (DDR version 4), JESD79-4C, originally published in January 2020, DDR5 (DDR version 5), JESD79-5B originally published in September 2022, LPDDR3 (Low Power DDR version 3), JESD209-3C, originally published in August 2015, LPDDR4 (LPDDR version 4), JESD209-4D, originally published by in June 2021, LPDDR5 (LPDDR version 5), JESD209-5B, originally published by in June 2021), WIO2 (Wide Input/output version 2), JESD229-2 originally published in August 2014, HBM (High Bandwidth Memory), JESD235B, originally published in December 2018, HBM2 (HBM version 2), JESD235D, originally published in January 2020, or HBM3 (HBM version 3), JESD238A, originally published in January 2023, or other memory technologies or combinations of memory technologies, as well as technologies based on derivatives or extensions of such above-mentioned specifications. The JEDEC standards or specifications are available at www.jedec.org.

Memory controller 120, as shown in FIG. 1, may represent one or more memory controller circuits or devices for system 100. Also, memory controller 120 can include circuitry logic and/or features configured to generate memory access commands in response to the execution of operations by processor 110. In some examples, memory controller 120 can access one or more memory device(s) 140. For these examples, memory device(s) 140 may be SDRAM devices in accordance with any the above-mentioned memory technology standards. Memory device(s) 140 may be organized and managed through one or more channels (e.g., included in channel(s) 130), where these channels can couple in parallel to multiple memory devices via buses and signal lines. The one or more channels included in channel(s) 130 can be independently operable. Thus, separate channels included in channel(s) 130 can be independently accessed and controlled, and the timing, data transfer, command and address exchanges, and other operations can be separate for each channel. Coupling can refer to an electrical coupling, communicative coupling, physical coupling, or a combination of these. Physical coupling can include direct contact. Electrical coupling, for example, includes an interface or interconnection that allows electrical flow between components, or allows signaling between components, or both. Communicative coupling, for example, includes connections, including wired or wireless, that enable components to exchange data.

According to some examples, settings for each channel are controlled by separate mode registers or other register settings, for example, maintained in register(s) 144 of memory device(s) 140. For these examples, memory controller 120 can manage separate memory channels coupled with separate memory devices from among memory device(s) 140 based on register(s) 144 maintained at a respective memory device. In one example, memory controller 120 can be part of or integrated with processor 110. For example, circuitry, logic and/or features of memory controller 120 can be implemented on a same die or implemented in a same system on a package (SoP) or same system of a chip (SoC) as processor 110.

In some examples, as shown in FIG. 1, memory controller 120 includes I/O interface circuitry 122 to couple to memory bus(es) or channel(s) 130. I/O interface circuitry 122 (as well as I/O interface circuitry 142 of memory device(s) 140) can include pins, pads, connectors, signal lines, traces, or wires, or other hardware to connect the devices, or a combination of these. I/O interface circuitry 122 may include a hardware interface. As shown in FIG. 1, I/O interface circuitry 122 includes at least drivers/transceivers for signal lines. Commonly, wires within an integrated circuit interface couple with a pad, pin, or connector to interface signal lines or traces or other wires between devices. I/O interface circuitry 122 can include drivers, receivers, transceivers, or termination, I/O buffers, or other circuitry or combinations of circuitry to exchange signals on the signal lines between memory controller 120 and memory device(s) 140 through channel(s) 130. The exchange of signals includes at least one of transmit or receive. While shown as coupling I/O interface circuitry 122 from memory controller 120 to I/O interface circuitry 142 of memory device(s) 140 through channel(s) 130, it will be understood that in an implementation of system 100 where groups of memory device(s) 140 are accessed in parallel, multiple memory devices can include I/O interface circuitry to couple with a same interface of memory controller 120. In an implementation of system 100 including one or more memory module(s) 170, I/O interface circuitry 142 may include interface hardware of memory module(s) 170 in addition to interface hardware for memory device(s) 140. Other memory controllers 120 may include multiple, separate interfaces to one or more memory devices of memory device(s) 140.

In some examples, memory controller 120 may be coupled with memory device(s) 140 via multiple signal lines included in channel(s) 130. The multiple signal lines may include at least a clock (CLK) 132, a command/address (CMD) 134, and a write data (DQ) and read data (DQ) 136, and zero or more other signal lines 138. Signal lines of channel(s) 130 coupled with CMD 134 can be referred to as a “command bus”, a “C/A bus” or an ADD/CMD bus, or some other designation indicating the transfer of commands. Signal lines of channel(s) 130 coupled with DQ 136 can be referred to as a “data bus”.

According to some examples, independent channels included in channel(s) 130 can have different clock signals, command buses, data buses, and other signal lines. For these examples, system 100 may be considered to have multiple “buses,” in the sense that an independent interface path routed through channel(s) 130 can be considered a separate bus. It will be understood that in addition to the signal lines mentioned above and shown in FIG. 1, a bus may also include at least one of strobe signaling lines, alert lines, auxiliary lines, or other signal lines, or a combination of these additional signal lines to be routed through channel(s) 130. It will also be understood that serial bus technologies can be used for transmitting signals between memory controller 120 and memory device(s) 140 via channel(s) 130. An example of a serial bus technology is 8B10B encoding and transmission of high-speed data with embedded clock over a single differential pair of signals in each direction. In some examples, CMD 134 represents signal lines shared in parallel with multiple memory device(s) 140. In other examples, multiple memory devices share encoding command signal lines of CMD 134, and each has a separate chip select (CS_n) signal line to select individual memory device(s) 140.

In some examples, the bus between memory controller 120 and memory device(s) 140 includes a subsidiary command bus routed via signal lines included in CMD 134 and a subsidiary data bus to carry the write and read data routed via signal lines included in DQ 136. In some examples, CMD 134 and DQ 136 may separately include bidirectional lines. In other examples, DQ 136 can include unidirectional write signal lines to write data from the host to memory and unidirectional lines to read data from the memory to the host.

According to some examples, in accordance with a chosen memory technology and system design, signals lines included in other 138 can augment a memory bus or subsidiary bus. For example, strobe line signal lines for a DQS. Based on a design of system 100, or memory technology implementation, channel(s) 130 can facilitate more or less bandwidth per memory device included in memory device(s) 140. Channel(s) 130 can support memory devices included in memory device(s) 140 that have a sized interface such as an x32 interface, an x16 interface, an x8 interface, or other sized interface. The convention “xW,” where W is an integer that refers to an interface size or width of the interface of memory device(s) 140, which represents a number of signal lines to exchange data with memory controller 120. The interface size of these memory devices can be a controlling factor on how many memory devices may be used concurrently per channel of channel(s) 130 in system 100 or coupled in parallel to the same signal lines. In some examples, high bandwidth memory devices, wide interface memory devices, or stacked memory devices, or combinations, can enable wider or larger sized interfaces, such as an x128 interface, a nx256 interface, an x512 interface, an x1024 interface, or other interface sizes or widths.

In some examples, memory device(s) 140 and memory controller 120 exchange data over a data bus via signal lines coupled with DQ 136 in a burst, or a sequence of consecutive data transfers. The burst corresponds to a number of transfer cycles, which can be related to a bus frequency. A given transfer cycle can be a whole clock cycle for transfers occurring on a same clock or strobe signal edge (e.g., on the rising edge). In some examples, every clock cycle, referring to a cycle of the system clock, can be separated into multiple unit intervals (UIs), where each UI is a transfer cycle. For example, double data rate transfers trigger on both edges of the clock signal (e.g., rising and falling). A burst can last for a configured number of UIs, which can be a configuration stored in a register, or triggered on the fly. For example, a sequence of eight consecutive transfer periods can be considered a burst length 8 (BL8), and each memory device(s) 140 can transfer data on each UI. Thus, a x8 memory device operating on BL8 can transfer 64 bits of data (8 data signal lines times 8 data bits transferred per line over the burst). It will be understood that this simple example is merely an illustration and is not limiting.

According to some examples, memory device(s) 140 represent memory resources for system 100. For these examples, each memory device included in memory device(s) 140 is a separate memory die. Separate memory devices can interface with multiple (e.g., 2) channels per device or die. A given memory device of memory device(s) 140 can include I/O interface circuitry 142 and may have a bandwidth determined by an interface width associated with an implementation or configuration of the given memory device (e.g., x16 or x8 or some other interface width). I/O interface circuitry 142 can enable the memory devices to interface with memory controller 120. I/O interface circuitry 142 can include a hardware interface and operate in coordination with I/O interface circuitry 122 of memory controller 120.

In some examples, multiple memory device(s) 140 can be connected in parallel to the same command and data buses (e.g., via CMD 134 and DQ136). In other examples, multiple memory device(s) 140 can be connected in parallel to the same command bus but connected to different data buses. For example, system 100 can be configured with multiple memory device(s) 140 coupled in parallel, with each memory device responding to a command, and accessing memory resources 160 internal to each memory device. For a write operation, an individual memory device of memory device(s) 140 can write a portion of the overall data word, and for a read operation, the individual memory device can fetch a portion of the overall data word. As non-limiting examples, a specific memory device can provide or receive, respectively, 8 bits of a 128-bit data word for a read or write operation, or 8 bits or 16 bits (depending for a x8 or a x16 device) of a 256-bit data word. The remaining bits of the word can be provided or received by other memory devices in parallel.

According to some examples, memory device(s) 140 can be disposed directly on a motherboard or host system platform (e.g., a PCB (printed circuit board) on which processor 110 is disposed) of a computing device. Memory device(s) 140 can be organized into memory module(s) 170. In some examples, memory module(s) 170 can represent dual inline memory modules (DIMMs). In some examples, memory module(s) 170 can represent other organizations or configurations of multiple memory devices that share at least a portion of access or control circuitry, which can be a separate circuit, a separate device, or a separate board from the host system platform. In some examples, memory module(s) 170 can include multiple memory device(s) 140, and memory module(s) 170 can include support for multiple separate channels to the included memory device(s) 140 disposed on them.

In some examples, memory device(s) 140 can be incorporated into a same package as memory controller 120. For example, incorporated in a multi-chip-module (MCM), a package-on-package with through-silicon via (TSV), or other techniques or combinations. Similarly, in some examples, memory device(s) 140 can be incorporated into memory module(s) 170, which themselves can be incorporated into the same package as memory controller 120. It will be appreciated that for these and other examples, memory controller 120 can be part of or integrated with processor 110.

As shown in FIG. 1, in some examples, memory device(s) 140 include memory resources 160. Memory resources 160 can represent individual arrays of memory locations or storage locations for data. Memory resources 160 can be managed as rows of data, accessed via wordline (rows) and bitline (individual bits within a row) control. Memory resources 160 can be organized as separate channels, ranks, and banks of memory. A channel organization can refer to an independent control path to storage locations within one or more memory device(s) 140. A rank organization can refer to common locations across multiple memory devices (e.g., same row addresses within different memory devices). A bank organization can refer to arrays of memory locations within a given memory device of memory device(s) 140. Banks can be divided into sub-banks with at least a portion of shared circuitry (e.g., drivers, signal lines, control logic) for the sub-banks, allowing separate addressing and access. It will be understood that channels, ranks, banks, sub-banks, bank groups, or other organizations of the memory locations, and combinations of the organizations, can overlap in their application to access memory resources 160. For example, the same physical memory locations can be accessed over a specific channel as a specific bank, which can also belong to a rank. Thus, the organization of memory resources 160 can be understood in an inclusive, rather than exclusive, manner.

According to some examples, as shown in FIG. 1, memory device(s) 140 include one or more register(s) 144. Register(s) 144 can represent one or more storage devices or storage locations that provide configuration or settings for operation memory device(s) 140. In one example, register(s) 144 can provide a storage location for memory device(s) 140 to store data for access by memory controller 120 as part of a control or management operation. For example, register(s) 144 can include one or more mode registers (MRs) and/or can include one or more multipurpose registers.

In some examples, writing to or programming one or more registers of register(s) 144 can configure memory device(s) 140 to operate in different “modes” (e.g., a memory scrubbing mode). For these examples, command information written to or programmed to the one or more register can trigger different modes within memory device(s) 140. Additionally, or in the alternative, different modes can also trigger different operations from address information or other signal lines depending on the triggered mode. Programmed settings of register(s) 144 can indicate or trigger configuration of I/O settings. For example, configuration of timing, termination, on-die termination (ODT), driver configuration, or other I/O settings.

According to some examples, memory device(s) 140 includes ODT 146 as part of the interface hardware associated with I/O interface circuitry 142. ODT 146 can provide settings for impedance to be applied to the interface to specified signal lines. For example, ODT 146 can be configured to apply impedance to signal lines included in DQ 136 or CMD 134. The ODT settings for ODT 146 can be changed based on whether a memory device of memory device(s) 140 is a selected target of an access operation or a non-target memory device. ODT settings for ODT 146 can affect timing and reflections of signaling on terminated signal lines included in, for example, CMD 134 or DQ 136. Control over ODT setting for ODT 146 can enable higher-speed operation with improved matching of applied impedance and loading. Impedance and loading can be applied to specific signal lines of channel(s) 130 coupled with I/O interface circuitry 142, 122 (e.g., coupled with CMD 134 and DQ 136) and is not necessarily applied to all signal lines routed through channel(s) 130.

In some examples, as shown in FIG. 1, memory device(s) 140 includes controller 150. Controller 150 can represent control logic within memory device(s) 140 to control internal operations within memory device(s) 140. For example, controller 150 decodes commands sent by memory controller 120 and generates internal operations to execute or satisfy the commands. Controller 150 can be referred to as an internal controller and is separate from memory controller 120 of the host. Controller 150 can include logic and/or features to determine what mode is selected based on programmed or default settings indicated in register(s) 144 and configure the internal execution of operations for access to memory resources 160 or other operations based on the selected mode. Controller 150 generates control signals to control the routing of bits within memory device(s) 140 to provide a proper interface for the selected mode and direct a command to the proper memory locations or addresses of memory resources 160. Controller 150 includes command (Cmd) logic 152, which can decode command encoding received on command and address signal lines. Thus, Cmd logic 152 can be or can include a command decoder. With Cmd logic 152, memory device can identify commands and generate internal operations to execute requested commands.

Referring again to memory controller 120, memory controller 120 includes command (Cmd) logic 121, which represents logic and/or features of memory controller 120 to generate commands to send to memory device(s) 140. The generation of the commands can refer to the command prior to scheduling, or the preparation of queued commands ready to be sent. Generally, the signaling in memory subsystems includes address information within or accompanying the command to indicate or select one or more memory locations where memory device(s) 140 should execute the command. In response to scheduling of transactions for memory device(s) 140, memory controller 120 can issue commands via I/O interface circuitry 122 to cause memory device(s) 140 to execute the commands. In some examples, controller 150 of memory device(s) 140 receives and decodes command and address information received via I/O interface circuitry 142 from memory controller 120. Based on the received command and address information, controller 150 can control the timing of operations of the logic, features and/or circuitry within memory device(s) 140 to execute the commands. Controller 150 can be arranged to operate in compliance with standards or specifications (e.g., DDR5) to meet timing and signaling requirements for memory device(s) 140.

According to some examples, memory controller 120 includes a scheduler 125, which represents logic and/or features to generate and order transactions to send to memory device(s) 140. From one perspective, the primary function of memory controller 120 could be said to schedule memory access and other transactions to memory device(s) 140. Such scheduling can include generating the transactions themselves to implement the requests for data by processor 110 and to maintain integrity of the data (e.g., such as with commands related to refresh). Transactions can include one or more commands, and result in the transfer of commands or data or both over one or multiple timing cycles such as clock cycles or unit intervals. Transactions can be for access such as read or write or related commands or a combination, and other transactions can include memory management commands for configuration, settings, data integrity (e.g., memory scrubbing), or other commands or a combination.

In some examples, memory controller 120 includes refresh (Ref) logic 123. Ref logic 123 can be used for memory resources that are volatile and need to be refreshed to retain a deterministic state. Ref logic 123, for example, can indicate a location for refresh, and a type of refresh to perform. Ref logic 123 can trigger self-refresh within memory device(s) 140 or execute external refreshes which can be referred to as auto refresh commands by sending refresh commands, or a combination. According to some examples, system 100 supports all bank refreshes as well as per bank refreshes. All bank refreshes cause the refreshing of banks within all memory device(s) 140 coupled in parallel. Per bank refreshes cause the refreshing of a specified bank within a specified memory device of memory device(s) 140. In some examples, controller 150 within memory device(s) 140 includes a Ref logic 154 to apply refresh within memory device(s) 140. Ref logic 154, for example, may generate internal operations to perform refresh in accordance with an external refresh received from memory controller 120. Ref logic 154 can determine if a refresh is directed to memory device(s) 140 and determine what memory resources 160 to refresh in response to the command.

In some examples, memory controller 120 includes scrub circuitry 129. As described in more detail below, scrub circuitry 129 can include logic and/or features to implement a memory scrubbing operation to detect errors in ECC encoded data stored to memory resources 160. The memory scrubbing operation, for example, can be implemented as a patrol memory scrubbing operation and can be associated with additional RAS features to include, but not limited to hPPR, sPPR, or resilvering.

According to some examples, memory controller 120 includes ECC circuitry 127. As described in more detail below, ECC circuitry 127 can include logic and/or features to correct detected errors in ECC encoded data. The detected errors in the ECC encoded data, for example, can be detected by logic and/or features of scrub circuitry 129 during a memory scrubbing operation of data stored to memory resources such as memory resources 160. Detected errors, for example, can be determined as correctable errors by the logic and/or features of scrub circuitry 129 following a first scrub read of the memory resources during the memory scrubbing operation. Correctable errors can be based on what ECC methodology was used to encode data stored to memory resources 160. That methodology could be capable of correcting one to multiple bit errors detected by the logic and/or features of scrub circuitry 129. The particular types of ECC methodology, which can be adapted from conventional error detection/correction techniques and mechanisms, and the amount of bit errors that can be corrected by that ECC methodology are not discussed to avoid obscuring features of memory scrubbing associated with RAS as described in this disclosure.

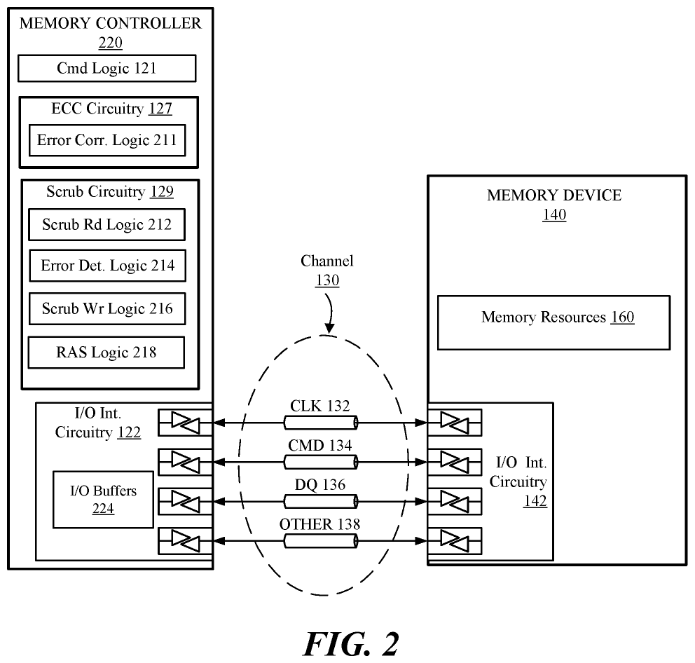

FIG. 2 illustrates a more detailed example of portions of system 100. In some examples, as shown in FIG. 2, portions of system 100 include memory controller 120 and a memory device 140. For these examples, also as shown in FIG. 2, memory controller 120 also includes, Cmd logic 121, ECC circuitry 127, scrub circuitry 129 and I/O interface circuitry 122. CLK 132, CMD 134, DQ 136 and other 138 signal lines included in channel 130 are also shown in FIG. 2 and these signal lines of channel 130 can couple with memory device 140 through I/O interface circuitry 142.

In some examples, memory controller 120 can be an application specific integrated circuitry (ASIC), field programmable gate array (FPGA) or integrated portion of a processor or a processor circuit. Also, Cmd logic 121, ECC circuitry 127 and/or scrub circuitry 129 can be part of a same ASIC, FPGA or integrated portion of the processor or the processor circuit that includes memory controller 120. Alternatively, Cmd logic 121, ECC circuitry 127 and/or scrub circuitry 129 can be separate ASICs or FPGAs or can be collocated on a same ASIC die or FPGA die.

According to some examples, as shown in FIG. 2, scrub circuitry 129 includes a scrub read (Rd) logic 212, an error detection (det.) logic 214, a scrub write (Wr) logic 216, or a RAS logic 218. As described more below, this logic of scrub circuitry 129 can be configured to implement a memory scrubbing operation or process to access ECC encoded data stored to memory resources 160, detect correctable errors in the accessed ECC encoded data, and then indicate to logic and/or features of ECC circuitry 127 such as error correction (corr.) logic 211 that the accessed ECC encoded data needs to be corrected. Once the accessed ECC encoded data is corrected by error corr. logic 211, the corrected ECC encoded data, for example, can referred to as scrubbed ECC encoded data and that scrubbed ECC encoded data can be written back to memory resources 160. The scrubbed ECC encoded data that was written back to memory resources 160 can be subsequently accessed by logic of scrub circuitry 129 and if errors are detected for this accessed scrubbed ECC encoded data, regardless of whether the errors are correctable, RAS features to include, but not limited to hPPR, sPPR, or resilvering can be triggered by the logic of scrub circuitry 129. As a result, the RAS features can be triggered before an error threshold is met or exceeded and transient errors, soft errors or even hardware/memory device errors can be addressed in a timelier manner compared to waiting for the error threshold to be met or exceeded. I/O data buffers 224 coupled with or included in I/O interface circuitry 122 can be utilized by logic and/or features of ECC circuitry 127 and/or scrub circuitry 129 to at least temporarily store the accessed ECC encoded data, the scrubbed ECC encoded data or the written back scrubbed ECC encoded data. I/O buffers 224, for example, can include volatile or non-volatile types of memory maintained with and/or accessible through I/O circuitry interface 122 and can be configured to include read or write buffers.

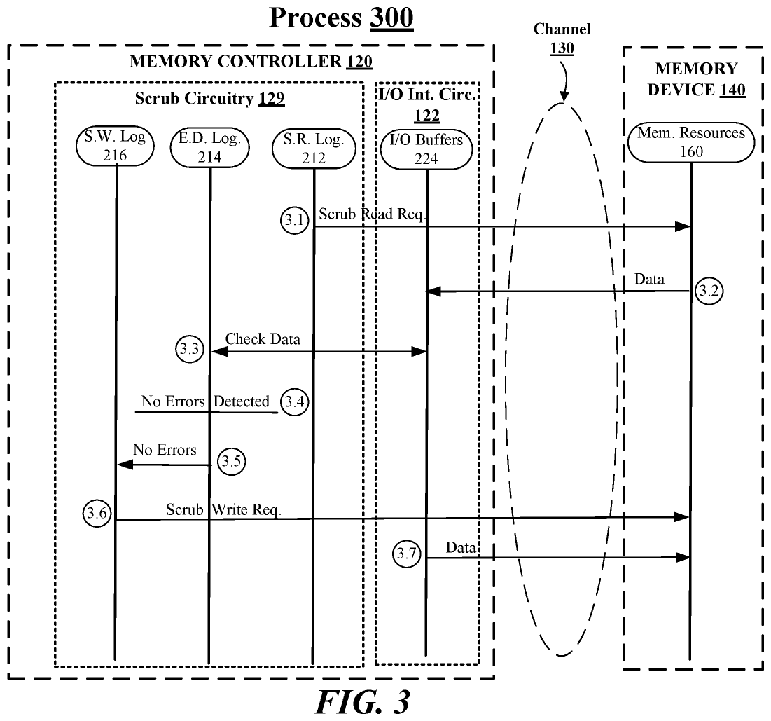

FIG. 3 illustrates an example process 300. In some examples, process 300 can represent techniques for patrol memory scrubbing of ECC encoded data stored to memory resources maintained at one or more memory devices in which no errors are detected. For these examples, elements of system 100 as shown in FIG. 1 or 2 can be related to process 300. These elements of system 100 can include memory controller 120, channel 130, memory resources 160 at memory device 140 and logic and/or features of scrub circuitry 129 such as, but not limited to, scrub Rd logic 212, error det. logic 214, or scrub Wr logic 216 and I/O buffers 224 of I/O interface circuitry 122. Example process 300 is not limited to implementations using just the above mentioned elements of system 100.

According to some examples, at 3.1 (Scrub Read Req.), scrub Rd logic 212 can cause a scrub read request to be sent through channel 130 (e.g., via CMD 134) to memory resources 160 at memory device 140. For these examples, the scrub read request can access ECC encoded data stored to a memory address mapped in system memory to one or more memory units or segment such as, but not limited to a memory bank or a memory sub-bank maintained at memory resources 160. Also, since this is a patrol memory scrub operation, the request is made while the one or more memory units or segments of memory resources 160 are in an idle state or not being currently accessed by an application and/or operating system.

In some examples, at 3.2 (Data), the scrub read request can result in ECC encoded data being read from memory resources 160 and at least temporarily stored to I/O buffers 224 at I/O interface circuitry 122.

According to some examples, at 3.3 (Check Data), responsive to the ECC encoded data being at temporarily stored to I/O buffers 224, error det. logic 214 can check the ECC encoded data for errors. Detection can be based on what ECC methodology was used to encode the data when stored to memory resources 160. For example, the ECC methodology can be based on block ECC codes or convolutional ECC codes.

In some examples, at 3.4 (No Errors Detected), error det. logic. 214 determines that the ECC encoded data has no detectable errors following the check of the ECC encoded data for errors.

According to some examples, at 3.5 (No Errors), error det. logic 214 can indicate to scrub Wr logic 216 that no errors were detected in the ECC encoded data.

In some examples, at 3.6, (Scrub Write Req.), scrub Wr logic 216, responsive to the indication that no errors were detected, can cause a scrub write request to be sent through channel 130 (e.g., via CMD 134) to memory resources 160 at memory device 140. For these examples, the scrub write request is to the same memory address mapped in system memory to the one or more memory units or segments maintained at resources 160 for which the scrub read request targeted as mentioned above at 3.1.

According to some examples, at 3.7 (Data), the ECC encoded data is written back to the same memory address mapped in system memory to the one or more memory units or segments maintained at resources 160. Process 300 can then come to an end.

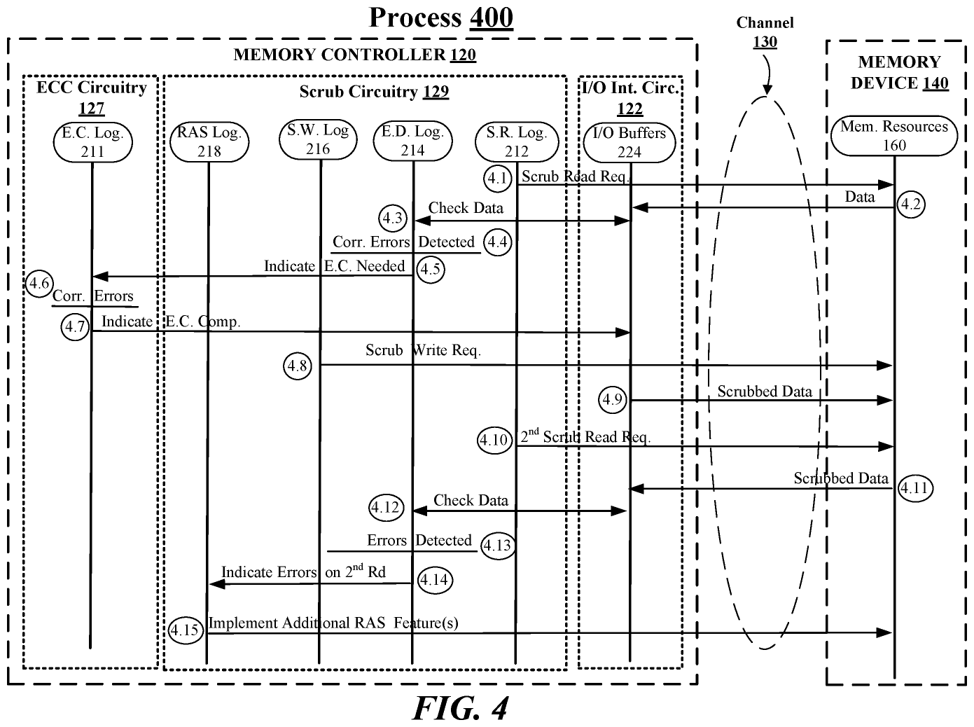

FIG. 4 illustrates an example process 400. In some examples, process 400 can represent techniques for patrol memory scrubbing of ECC encoded data stored to memory resources maintained at one or more memory devices in which correctable errors are detected and corrected/scrubbed and then upon a second scrub read of the scrubbed ECC encoded data, errors are again detected. The second detection of errors in the scrubbed ECC encoded data can trigger an implementation of additional RAS features. For these examples, elements of system 100 as shown in FIG. 1 or 2 can be related to process 400. These elements of system 100 can include memory controller 120, channel 130, memory resources 160 at memory device 140 and logic and/or features of scrub circuitry 129 such as, but not limited to, scrub Rd logic 212, error det. Logic 214, scrub Wr logic 216, or RAS logic 218 as well as logic and/or features of ECC circuitry 127 such as, but not limited to, error corr. logic 211 and I/O buffers 224 of I/O interface circuitry 122. Example process 400 is not limited to implementations using just the above mentioned elements of system 100.

According to some examples, at 4.1 (Scrub Read Req.), scrub Rd logic 212 can cause a scrub read request to be sent through channel 130 (e.g., via CMD 134) to memory resources 160 at memory device 140. Similar to what was mentioned above for process 300, the scrub read request can access ECC encoded data stored to a memory address mapped in system memory to one or more memory units or segment such as, but not limited to a memory bank or a memory sub-bank maintained at memory resources 160.

In some examples, at 4.2 (Data), the scrub read request can result in ECC encoded data being read from memory resources 160 and at least temporarily stored to I/O buffers 224 at I/O interface circuitry 122.

According to some examples, at 4.3 (Check Data), responsive to the ECC encoded data being at temporarily stored to I/O buffers 224, error det. logic 214 can check the ECC encoded data for correctable errors. Detection can depend on what ECC methodology was used to encode the data when stored to memory resources 160.

In some examples, at 4.4, error det. logic 214 detects correctable errors the checked data. For these examples, correctable errors can be based on the ECC methodology used to encode the check data. For example, if the ECC methodology used enables up to 4 bit errors to be corrected in the checked data, then as long as 4 or less bit errors are detected, then the checked data is deemed as having correctable errors.

According to some examples, at 4.5 (Indicate E.C. Needed), error det. logic 214 can indicate to error corr. logic 211 of ECC circuitry 127 that error correction is needed for the checked ECC encoded data. For these examples, error det. logic 214 can provide a pointer to I/O buffers 224 to error corr. logic 211 that will enable error corr. logic 211 to access the checked ECC encoded data.

According to some examples, at 4.6 (Corr. Errors), error corr. logic 211 accesses the ECC encoded data from I/O buffer 224 and corrects the bits errors detected by error det. logic 214. For these examples, error correction, as mentioned above for process 300, can be based on the ECC methodology used to encode the data to enable correction of some finite number of bit errors detected in the ECC encoded data.

In some examples, at 4.7, (Indicate E.C. Comp.), error corr. logic 211 can indicate to scrub Wr logic 216 that error correction has been completed. For these examples, error correction logic 214 can provide a pointer to I/O buffers 224 to scrub Wr logic 216 that will be used by scrub Wr logic 212 to request that the corrected/scrubbed ECC encoded data be written back to memory resources 160.

According to some examples, at 4.8, (Scrub Write Req.), scrub Wr logic 216, responsive to the indication that error correction has been completed, can cause a scrub write request to be sent through channel 130 (e.g., via CMD 134) to memory resources 160 at memory device 140. For these examples, the scrub write request is to the same memory address mapped in system memory to the one or more memory units or segments maintained at resources 160 for which the scrub read request targeted as mentioned above at 4.1.

In some examples, at 4.9 (Scrubbed Data), scrubbed ECC encoded data is written back to the same memory address mapped in system memory to the one or more memory units or segments maintained at resources 160.

According to some examples, at 4.10 (2^{nd} Scrub Read Req.), scrub Rd logic 212 can cause a second scrub read request to be sent through channel 130 to memory resources 160 at memory device 140. For these examples, the scrub read request is to the same memory address mapped in system memory to the one or more memory units or segments maintained at resources 160 for which the scrub write request targeted as mentioned above at 4.10.

In some examples, at 4.11 (Scrubbed Data), the second scrub read request can result in scrubbed ECC encoded data being read from memory resources 160 and at least temporarily stored to I/O buffers 224 at I/O interface circuitry 122.

According to some examples, at 4.12 (Check Scrubbed Data), responsive to the scrubbed ECC encoded data being at least temporarily stored to I/O buffers 224, error det. logic 214 can check the ECC encoded data that was previously scrubbed for errors. Different from the check implemented at 4.3, this check of the previously scrubbed ECC encoded data can be to check for any detectable errors, regardless of whether the errors are correctable.

In some examples, at 4.13, (Errors Detected), error det. logic 214 has detected errors in the ECC encoded data that was previously scrubbed for errors and was read a second time. The detected errors can be due to transient errors, soft errors or possible hardware errors at memory resources 160 and/or memory device 140.

According to some examples, at 4.14, (Indicate Errors on 2^{nd} Rd), error det. logic 214 can send an indication to RAS logic 218 that errors were detected in scrubbed ECC encoded data that was accessed via a second read from the same memory address mapped in system memory to the one or more memory units or segments maintained at resources 160 for which the first scrub read request targeted as mentioned above at 4.1 and to which the scrub write request mentioned in 4.8 also targeted.

In some examples, at 4.15 (Implement Additional RAS Feature(s)), RAS logic 218 can be configured to implement one or more additional RAS features responsive to the indication of errors on the second read. For example, sPPR can be implemented to temporarily remap the memory address used to access the ECC encoded data to a different memory unit or segment of memory resources 160 and then take the previously mapped memory unit or segment offline at least until a power cycle of memory device 140 occurs and/or a system-wide reboot/power cycle occurs. Also, the ECC encoded data that was stored to that offline memory unit or segment can be moved to the different memory unit or segment of memory resources 160 that was remapped to the memory address as part of another RAS feature such as a resilvering operation. Also the detected errors in the ECC encoded data can be corrected prior to being moved to the different memory unit. Alternatively, hPPR can be implemented to permanently disable the memory unit or segment. Process 400 then comes to an end.

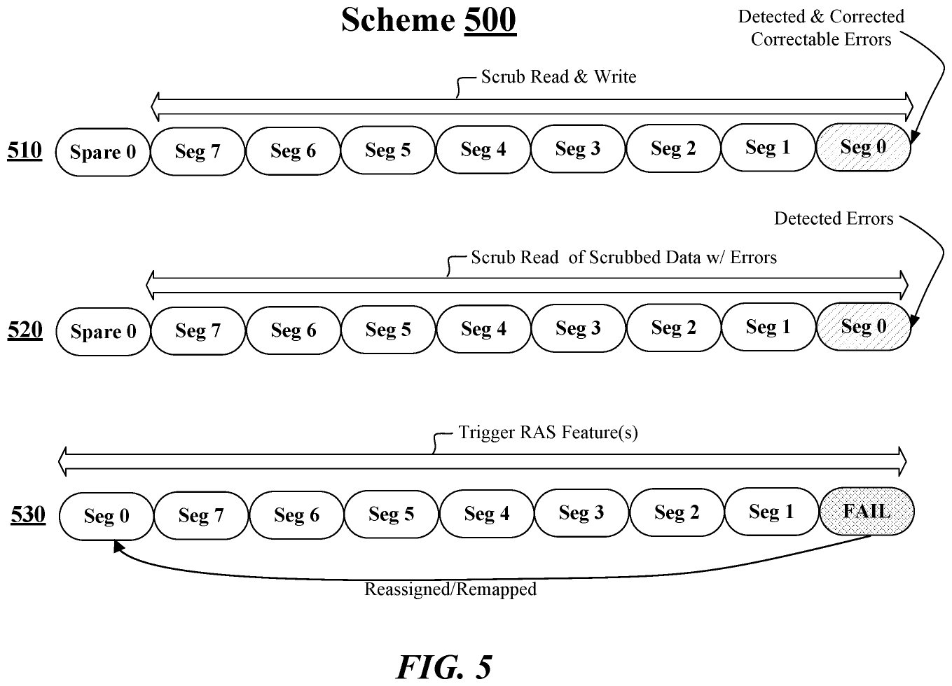

FIG. 5 illustrates an example scheme 500. In some examples, scheme 500 is an example scheme to implement an sPPR RAS feature. Although, a similar scheme can also be implemented for an hPPR RAS feature. For these examples, as shown in FIG. 5, a scrub read and write at phase 510 can be initiated that accesses ECC encoded data maintained in physical memory units assigned as segments (Segs) 0 to 7 (examples are not limited to 8 segments), checks for errors, and writes scrubbed data (e.g., detected correctable errors in the data are corrected) back to Segs 0 to 7. Also, a single physical memory unit is shown in FIG. 5 is being assigned as Spare 0, examples are not limited to a single physical memory unit assigned to be a spare segment, any number of physical memory units can be assigned to be spare segments. The physical memory units assigned as Segs 0 to 7 or assigned to be spare 0 can be maintained on a same or different memory device. For example, different DRAM chips or dies or different DIMMs.

According to some examples, at phase 510, a scrub read and write of Segs 0-7 is implemented. Also, a single physical memory unit is shown in FIG. 5 is being assigned as spare 0 and is not read from or written to during phase 510. The shaded pattern of Seg 0 shown in FIG. 5 can indicate that a correctable error was detected in ECC encoded data read from the physical memory unit assigned to Seg 0 and corrected/scrubbed ECC encoded data was written back to Seg 0.

In some examples, at phase 520, a second scrub read of Segs 0-7 is implemented. For these examples, ECC encoded data read from Seg 0 that was previously corrected/scrubbed at phase 510 had detected errors following the second scrub read (e.g., detected as described above for process 400).

According to some examples, at phase 530, an sPPR RAS feature can be triggered. Implementation of the sPPR RAS feature can include identifying the physical memory unit assigned to Seg 0 as a failed physical memory unit. For these examples, Seg 0 is identified as a failed segment based on the second scrub read detecting one or more errors. As part of the triggered RAS feature, the single physical memory unit assigned as spare 0 can then be used to at least temporarily replace the physical memory unit that was assigned as Seg 0. For example, as shown in FIG. 5, the single physical memory unit that was assigned as spare 0 can be reassigned/remapped as Seg 0 and the physical memory unit that was formerly assigned Seg 0 is marked as a failed physical memory unit and is at least temporarily disabled or taken offline. In some examples, the process to reassign/remap spare 0 to now be Seg 0 can follow an sPPR or hPPR process described in a JEDEC DDR standard such as, but not limited to, JEDEC's DDR5 standard. Once reassigned/remapped as Seg 0, the ECC encoded data that was maintained in the physical memory unit marked as failed, after correcting for detected bit errors, can be stored to the physical memory unit that was reassigned/remapped as Seg 0. Also, a system memory map can be updated to remap memory addresses that were once mapped to the marked-as-failed physical memory unit to now map to the physical memory unit that has been reassigned to Seg 0.

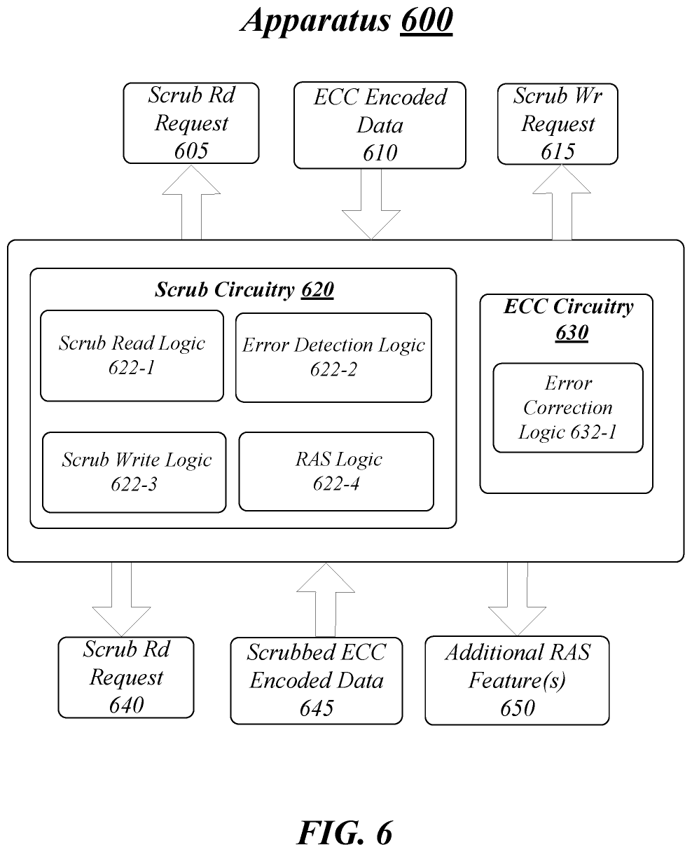

FIG. 6 illustrates an example block diagram for apparatus 600. Although apparatus 600 shown in FIG. 6 has a limited number of elements in a certain topology, it can be appreciated that the apparatus 600 can include more or less elements in alternate topologies as desired for a given implementation.

According to some examples, apparatus 600 can be a memory controller that includes, but is not limited to, a scrub circuitry 620 and an ECC circuitry 630. For these examples, scrub circuitry 620 or ECC circuitry 630 can be maintained on a same or separate ASIC or FPGA, or part of a same or different configurable logic, part of a same or different portion of a processor or processor circuit. For these examples, the same or different ASIC, FPGA, configurable logic, portion of a processor or processor circuit can be configured to support logic and/or features of scrub circuitry 620 arranged to operate similar to scrub circuitry 129 to support memory scrub operations that may trigger additional RAS features. The same or different ASIC, FPGA, configurable logic, portion of a processor or processor circuit can also be configured to support logic and/or features of ECC circuitry 630 arranged to operate similar to ECC circuitry 127 to correct correctable errors detected by the logic and/or features of scrub circuitry 620.

According to some examples, scrub circuitry 620 or ECC circuitry 630 can be arranged to implement one or more software or firmware implemented logic, modules, components, or features 622-a or 632-a (module, component, logic or feature can be used interchangeably in this context). It is worthy to note that “a” and “b” and “c” and similar designators as used herein are intended to be variables representing any positive integer. Thus, for example, if an implementation sets a value for a=4, then a complete set of software or firmware for modules, components or features 622-a to be implemented by scrub circuitry 620 can include features 622-1 to 622-4. The examples presented are not limited in this context and the different variables used throughout can represent the same or different integer values. Also, “logic”, “module”, “component” or “feature” can also include software/firmware stored in computer-readable media, and although types of logic or features are shown in FIG. 6 as discrete boxes, this does not limit these types of logic or features to storage in distinct computer-readable media components (e.g., a separate memory, etc.).

According to some examples, scrub circuitry 620 can include a scrub read logic 622-1. Scrub read logic 622-1 can send a scrub read request to obtain ECC encode data stored in a physical memory unit maintained at a memory device coupled with apparatus 600. For these examples, the scrub read request can be included in scrub read request 605.

In some examples, scrub circuitry 620 can include a scrub read logic 622-1. Scrub read logic 622-1 can receive the ECC encoded data response to the scrub read request. For these examples, the ECC encoded data is included in ECC encoded data 610.

According to some examples, scrub circuitry 620 can include an error detection logic 622-2. Error detection logic 622-2 can detect at least one error in the ECC encoded data. For these examples, responsive to detecting the error, error detection logic 622-2 can notify ECC circuitry that at least one error was detected.

In some examples, ECC circuitry 630 can include an error correction logic 632-1. Error correction logic 632-1 can correct the at least one error in the ECC encoded data to generate scrubbed ECC encoded data. For these examples, error correction logic 632-1 can notify scrub circuitry 620 that the ECC encoded data has been corrected/scrubbed.

According to some examples, scrub circuitry 620 can include a scrub write logic 622-3. Scrub write logic 622-3 can send a scrub write request to the memory device coupled with apparatus 600 to cause the corrected/scrubbed ECC encoded data to be stored in the physical memory unit maintained at the memory device. For these examples, the scrub write request can be included in scrub write request 615 and the corrected/scrubbed ECC encoded data can be included in scrubbed ECC encoded data 645.

According to some examples, scrub read logic 622-1 can send a second scrub read request to the memory device to obtain the corrected/scrubbed ECC encoded data stored in the physical memory unit. For these examples, the second scrub read request can be included in scrub read request 640.

In some examples, error detection logic 622-2 can detect at least one error in the scrubbed ECC encoded data. As shown in FIG. 6, scrub circuitry 620 can include a RAS logic 622-4. For these examples, responsive to detecting the error, error detection logic 622-2 can notify RAS logic 622-4 that at least one error was detected in the scrubbed ECC encoded data. RAS logic 622-4 can then trigger one or more RAS features that includes removal of the physical memory unit from a system memory map and a remap of system memory addresses previously associated with the physical memory unit to a second physical memory unit. The triggered one or more RAS features can be included in additional RAS feature(s) 650 (e.g., sPPR, hPPR, or resilvering)

Various components of apparatus 600 and a device or node implementing apparatus 600 can be communicatively coupled to each other by various types of communications media to coordinate operations. The coordination can involve the uni-directional or bi-directional exchange of information. For instance, the components can communicate information in the form of signals communicated over the communications media. The information can be implemented as signals allocated to various signal lines. In such allocations, each message is a signal. Further embodiments, however, can alternatively employ data messages. Such data messages can be sent across various connections. Example connections include parallel interfaces, serial interfaces, and bus interfaces.

Included herein is a logic flow related to apparatus 600 that can be representative of example methodologies for performing novel aspects for mitigating or preventing a possible side-channel attack to a shared processor cache. While, for purposes of simplicity of explanation, the one or more methodologies shown herein are shown and described as a series of acts, those skilled in the art will understand and appreciate that the methodologies are not limited by the order of acts. Some acts can, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology can be required for a novel implementation.

A logic flow can be implemented in software, firmware, and/or hardware. In software and firmware embodiments, a logic flow can be implemented by computer executable instructions stored on at least one non-transitory computer readable medium or machine readable medium, such as an optical, magnetic or semiconductor storage. The embodiments are not limited in this context.

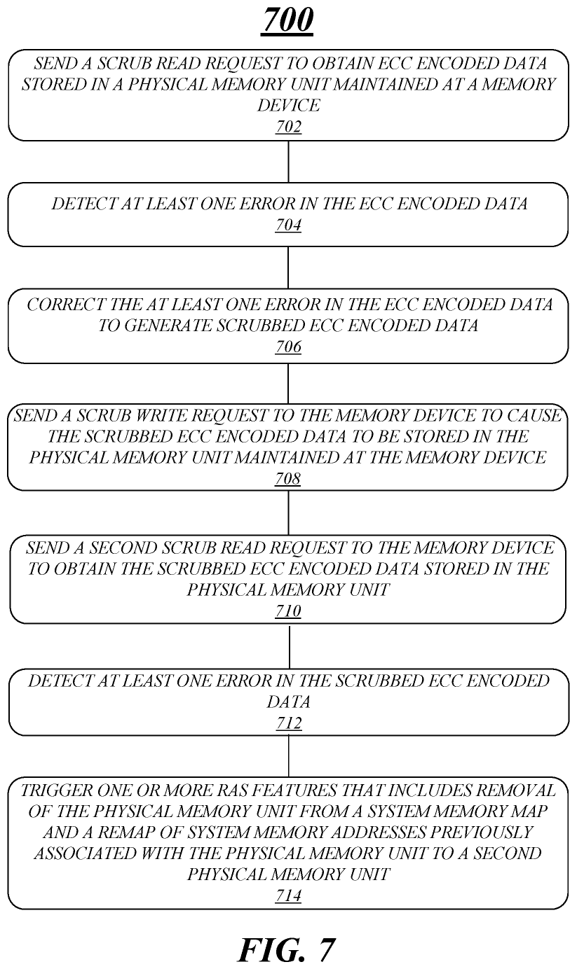

FIG. 7 illustrates an example logic flow 700. Logic flow 700 can be representative of some or all of the operations executed by one or more logic, features, or devices described herein, such as apparatus 600. More particularly, logic flow 700 can be implemented by at least logic and/or features of scrub circuitry 620 or ECC circuitry 630 to include, but not limited to, scrub read logic 622-1, error detection logic 622-2, scrub write logic 622-3, RAS logic 622-4 or error correction logic 632-1.

According to some examples, logic flow 700 at block 702 can send a scrub read request to obtain ECC encoded data stored in a physical memory unit maintained at a memory device. For these examples, receive feature 822-1 can receive the request. For these examples, scrub read logic 622-1 can send the scrub read request.

In some examples, logic flow 700 at block 704 can detect at least one error in the ECC encoded data. For these examples, error detection logic 622-2 can detect the at least one error in the obtained ECC encoded data.

In some examples, logic flow 700 at block 706 can correct the at least one error in the ECC encoded data to generate scrubbed ECC encoded data. For these examples, error correction logic 632-1 can correct the at least one error.

According to some examples, logic flow 700 at block 708 can send a scrub write request to the memory device to cause the scrubbed ECC encoded data to be stored in the physical memory unit maintained at the memory device. For these examples, scrub write logic 622-3 can send the scrub write request.

In some examples, logic flow 700 at block 710 can send a second scrub read request to the memory device to obtain the scrubbed ECC encoded data stored in the physical memory unit. For these examples, scrub read logic 622-1 can send the second scrub read request.

According to some examples, logic flow 700 at block 712 can detect at least one error in the scrubbed ECC encoded data. For these examples, error detection logic 622-2 can detect the at least one error in the obtained scrubbed ECC encoded data.

According to some examples, logic flow 700 at block 714 can trigger one or more RAS features that includes removal of the physical memory unit from a system memory map and a remap of system memory addresses previously associated with the physical memory unit to a second physical memory unit. For these examples, RAS logic 622-4 can trigger the one or more RAS features.

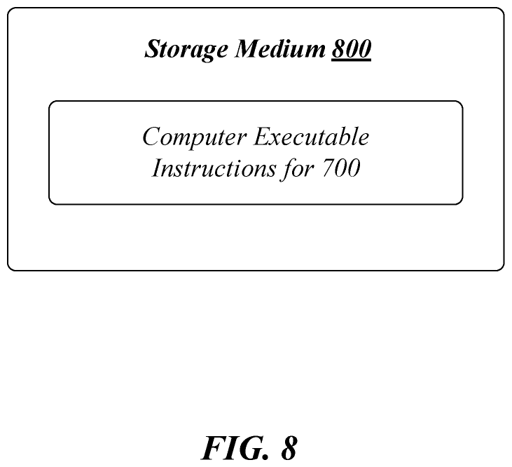

FIG. 8 illustrates an example storage medium 800. As shown in FIG. 8, the first storage medium includes a storage medium 800. The storage medium 800 can comprise an article of manufacture. In some examples, storage medium 800 can include any non-transitory computer readable medium or machine readable medium, such as an optical, magnetic or semiconductor storage. Storage medium 800 can store various types of computer executable instructions, such as instructions to implement logic flow 700. Examples of a computer readable or machine readable storage medium can include any tangible media capable of storing electronic data, including volatile memory or non-volatile memory, removable or non-removable memory, erasable or non-erasable memory, writeable or re-writeable memory, and so forth. Examples of computer executable instructions can include any suitable type of code, such as source code, compiled code, interpreted code, executable code, static code, dynamic code, object-oriented code, visual code, and the like. The examples are not limited in this context.

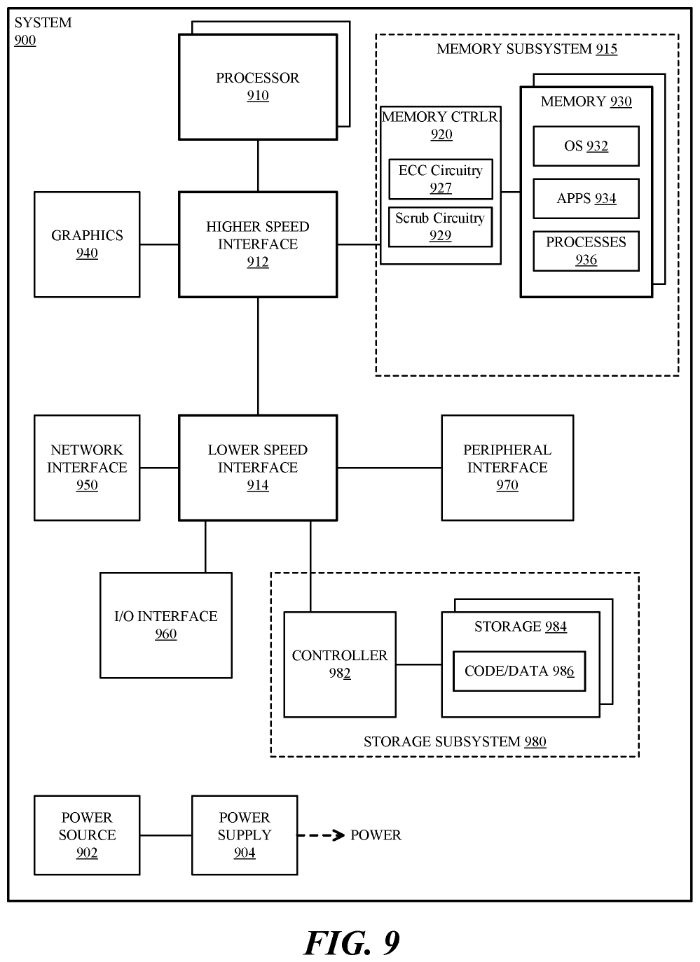

FIG. 9 illustrates an example system 900. In some examples, system 900 may be a computing system in which a memory scrubbing operation that triggers one or more additional RAS features can be implemented. System 900 represents a computing device in accordance with any example described herein, and can be a laptop computer, a desktop computer, a tablet computer, a server, a gaming or entertainment control system, a scanner, copier, printer, routing or switching device, embedded computing device, a smartphone, a wearable device, an internet-of-things device or other electronic device.

System 900 includes processor 910, which provides processing, operation management, and execution of instructions for system 900. Processor 910 can include any type of microprocessor, central processing unit (CPU), graphics processing unit (GPU), processing core, or other processing hardware to provide processing for system 900, or a combination of processors. Processor 910 controls the overall operation of system 900, and can be or include, one or more programmable general-purpose or special-purpose microprocessors, digital signal processors (DSPs), programmable controllers, ASICs, FPGAs, programmable logic devices (PLDs), or the like, or a combination of such devices.

In one example, system 900 includes interface 912 coupled to processor 910, which can represent a higher speed interface or a high throughput interface for system components that needs higher bandwidth connections, such as memory subsystem 915 or graphics interface components 940. Interface 912 represents an interface circuit, which can be a standalone component or integrated onto a processor die. Where present, graphics interface 940 interfaces to graphics components for providing a visual display to a user of system 900. In one example, graphics interface 940 can drive a high definition (HD) display that provides an output to a user. High definition can refer to a display having a pixel density of approximately 100 PPI (pixels per inch) or greater and can include formats such as full HD (e.g., 1080p), retina displays, 4K (ultra-high definition or UHD), or others. In one example, the display can include a touchscreen display. In one example, graphics interface 940 generates a display based on data stored in memory 930 or based on operations executed by processor 910 or both. In one example, graphics interface 940 generates a display based on data stored in memory 930 or based on operations executed by processor 910 or both.

Memory subsystem 915 represents the main memory of system 900 and provides storage for code to be executed by processor 910, or data values to be used in executing a routine. Memory 930 of memory subsystem 915 may include one or more memory devices such as read-only memory (ROM), flash memory, one or more varieties of random access memory (RAM) such as DRAM, or other memory devices, or a combination of such devices. Memory 930 stores and hosts, among other things, operating system (OS) 932 to provide a software platform for execution of instructions in system 900. Additionally, applications 934 can execute on the software platform of OS 932 from memory 930. Applications 934 represent programs that have their own operational logic to perform execution of one or more functions. Processes 936 represent agents or routines that provide auxiliary functions to OS 932 or one or more applications 934 or a combination. OS 932, applications 934, and processes 936 provide software logic to provide functions for system 900. In one example, memory subsystem 915 includes memory controller 920, which is a memory controller to generate and issue commands to memory 930. It will be understood that memory controller 920 could be a physical part of processor 910 or a physical part of interface 912. For example, memory controller 920 can be an integrated memory controller, integrated onto a circuit with processor 910.

While not specifically illustrated, it will be understood that system 900 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a HyperTransport or industry standard architecture (ISA) bus, a small computer system interface (SCSI) bus, a universal serial bus (USB), or an Institute of Electrical and Electronics Engineers (IEEE) standard 1394 bus.

In one example, system 900 includes interface 914, which can be coupled to interface 912. Interface 914 can be a lower speed interface than interface 912. In one example, interface 914 represents an interface circuit, which can include standalone components and integrated circuitry. In one example, multiple user interface components or peripheral components, or both, couple to interface 914. Network interface 950 provides system 900 the ability to communicate with remote devices (e.g., servers or other computing devices) over one or more networks. Network interface 950 can include an Ethernet adapter, wireless interconnection components, cellular network interconnection components, USB (universal serial bus), or other wired or wireless standards-based or proprietary interfaces. Network interface 950 can exchange data with a remote device, which can include sending data stored in memory or receiving data to be stored in memory.

In one example, system 900 includes one or more input/output (I/O) interface(s) 960. I/O interface(s) 960 can include one or more interface components through which a user interacts with system 900 (e.g., audio, alphanumeric, tactile/touch, or other interfacing). Peripheral interface 970 can include any hardware interface not specifically mentioned above. Peripherals refer generally to devices that connect dependently to system 900. A dependent connection is one where system 900 provides the software platform or hardware platform or both on which operation executes, and with which a user interacts.

In one example, system 900 includes storage subsystem 980 to store data in a nonvolatile manner. In one example, in certain system implementations, at least certain components of storage subsystem 980 can overlap with components of memory subsystem 920. Storage subsystem 980 includes storage device(s) 984, which can be or include any conventional medium for storing large amounts of data in a nonvolatile manner, such as one or more magnetic, solid state, or optical based disks, or a combination. Storage device(s) 984 holds code or instructions and data 986 in a persistent state (i.e., the value is retained despite interruption of power to system 900). Storage device(s) 984 can be generically considered to be a “memory,” although memory 930 is typically the executing or operating memory to provide instructions to processor 910. Whereas storage device(s) 984 is nonvolatile, memory 930 can include volatile memory (i.e., the value or state of the data is indeterminate if power is interrupted to system 900). In one example, storage subsystem 980 includes controller 982 to interface with storage device(s) 984. In one example controller 982 is a physical part of interface 914 or processor 910 or can include circuits or logic in both processor 910 and interface 914.

Power source 902 provides power to the components of system 900. More specifically, power source 902 typically interfaces to one or multiple power supplies 904 in system 900 to provide power to the components of system 900. In one example, power supply 904 includes an AC to DC (alternating current to direct current) adapter to plug into a wall outlet. Such AC power can be renewable energy (e.g., solar power) power source 902. In one example, power source 902 includes a DC power source, such as an external AC to DC converter. In one example, power source 902 or power supply 904 includes wireless charging hardware to charge via proximity to a charging field. In one example, power source 902 can include an internal battery or fuel cell source.

In one example, memory controller 920 of memory subsystem 915 includes ECC circuitry 927 and scrub circuitry 929 to implement memory scrubbing operations associated with one or more RAS features. These memory scrubbing operations may be in accordance with any example described herein.

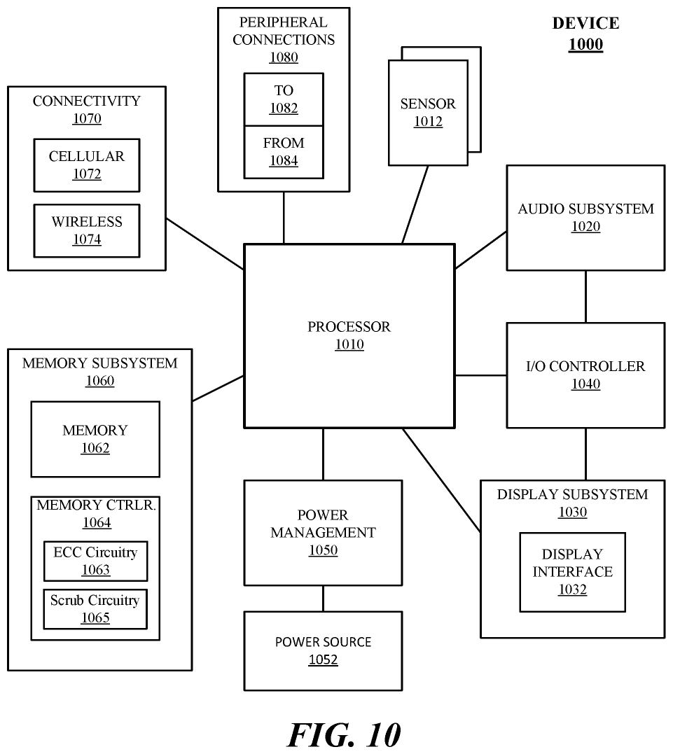

FIG. 10 illustrates an example device 1000. In some examples, device 1000 may be a mobile device in which a memory system may implement a CA training mode. Device 1000 represents a mobile computing device, such as a computing tablet, a mobile phone or smartphone, a wireless-enabled e-reader, wearable computing device, an internet-of-things device or other mobile device, or an embedded computing device. It will be understood that certain of the components are shown generally, and not all components of such a device are shown in device 1000.

Device 1000 includes processor 1010, which performs the primary processing operations of device 1000. Processor 1010 can include one or more physical devices, such as microprocessors, application processors, microcontrollers, programmable logic devices, or other processing means. The processing operations performed by processor 1010 include the execution of an operating platform or operating system on which applications and device functions are executed. The processing operations include operations related to I/O (input/output) with a human user or with other devices, operations related to power management, operations related to connecting device 1000 to another device, or a combination. The processing operations can also include operations related to audio I/O, display I/O, or other interfacing, or a combination. Processor 1010 can execute data stored in memory. Processor 1010 can write or edit data stored in memory.

In one example, device 1000 includes one or more sensors 1012. Sensors 1012 represent embedded sensors or interfaces to external sensors, or a combination. Sensors 1012 enable device 1000 to monitor or detect one or more conditions of an environment or a device in which device 1000 is implemented. Sensors 1012 can include environmental sensors (such as temperature sensors, motion detectors, light detectors, cameras, chemical sensors (e.g., carbon monoxide, carbon dioxide, or other chemical sensors)), pressure sensors, accelerometers, gyroscopes, medical or physiology sensors (e.g., biosensors, heart rate monitors, or other sensors to detect physiological attributes), or other sensors, or a combination. Sensors 1012 can also include sensors for biometric systems such as fingerprint recognition systems, face detection or recognition systems, or other systems that detect or recognize user features. Sensors 1012 should be understood broadly, and not limiting on the many different types of sensors that could be implemented with device 10000. In one example, one or more sensors 1012 couples to processor 1010 via a frontend circuit integrated with processor 1010. In one example, one or more sensors 1012 couples to processor 1010 via another component of device 10000.

In one example, device 1000 includes audio subsystem 1020, which represents hardware (e.g., audio hardware and audio circuits) and software (e.g., drivers, codecs) components associated with providing audio functions to the computing device. Audio functions can include speaker or headphone output, as well as microphone input. Devices for such functions can be integrated into device 1000 or connected to device 1000. In one example, a user interacts with device 1000 by providing audio commands that are received and processed by processor 1010.

Display subsystem 1030 represents hardware (e.g., display devices) and software components (e.g., drivers) that provide a visual display for presentation to a user. In one example, the display includes tactile components or touchscreen elements for a user to interact with the computing device. Display subsystem 1030 includes display interface 1032, which includes the particular screen or hardware device used to provide a display to a user. In one example, display interface 1032 includes logic separate from processor 1010 (such as a graphics processor) to perform at least some processing related to the display. In one example, display subsystem 1030 includes a touchscreen device that provides both output and input to a user. In one example, display subsystem 1030 includes a high definition (HD) display that provides an output to a user. High definition can refer to a display having a pixel density of approximately 100 PPI (pixels per inch) or greater and can include formats such as full HD (e.g., 1080p), retina displays, 4K (ultra-high definition or UHD), or others. In one example, display subsystem includes a touchscreen display. In one example, display subsystem 1030 generates display information based on data stored in memory or based on operations executed by processor 1010 or both.

I/O controller 1040 represents hardware devices and software components related to interaction with a user. I/O controller 1040 can operate to manage hardware that is part of audio subsystem 1020, or display subsystem 1030, or both. Additionally, I/O controller 1040 illustrates a connection point for additional devices that connect to device 1000 through which a user might interact with the system. For example, devices that can be attached to device 1000 might include microphone devices, speaker or stereo systems, video systems or other display device, keyboard or keypad devices, or other I/O devices for use with specific applications such as card readers or other devices.

As mentioned above, I/O controller 1040 can interact with audio subsystem 1020 or display subsystem 1030 or both. For example, input through a microphone or other audio device can provide input or commands for one or more applications or functions of device 1000. Additionally, audio output can be provided instead of or in addition to display output. In another example, if display subsystem includes a touchscreen, the display device also acts as an input device, which can be at least partially managed by I/O controller 1040. There can also be additional buttons or switches on device 1000 to provide I/O functions managed by I/O controller 1040.

In one example, I/O controller 1040 manages devices such as accelerometers, cameras, light sensors or other environmental sensors, gyroscopes, global positioning system (GPS), or other hardware that can be included in device 1000, or sensors 1012. The input can be part of direct user interaction, as well as providing environmental input to the system to influence its operations (such as filtering for noise, adjusting displays for brightness detection, applying a flash for a camera, or other features).

In one example, device 1000 includes power management 1050 that manages battery power usage, charging of the battery, and features related to power saving operation. Power management 1050 manages power from power source 1052, which provides power to the components of device 10000. In one example, power source 1052 includes an AC to DC (alternating current to direct current) adapter to plug into a wall outlet. Such AC power can be renewable energy (e.g., solar power, motion based power). In one example, power source 1052 includes only DC power, which can be provided by a DC power source, such as an external AC to DC converter. In one example, power source 1052 includes wireless charging hardware to charge via proximity to a charging field. In one example, power source 1052 can include an internal battery or fuel cell source.

Memory subsystem 1060 includes memory device(s) 1062 for storing information in device 1000. Memory subsystem 1060 can include nonvolatile (state does not change if power to the memory device is interrupted) or volatile (state is indeterminate if power to the memory device is interrupted) memory devices, or a combination. Memory subsystem 1060 can store application data, user data, music, photos, documents, or other data, as well as system data (whether long-term or temporary) related to the execution of the applications and functions of device 10000. In one example, memory subsystem 1060 includes memory controller 1064 (which could also be considered part of the control of device 10000 and could potentially be considered part of processor 1010). Memory controller 1064 includes a scheduler to generate and issue commands to control access to memory device(s) 1062.

Connectivity 1070 includes hardware devices (e.g., wireless or wired connectors and communication hardware, or a combination of wired and wireless hardware) and software components (e.g., drivers, protocol stacks) to enable device 1000 to communicate with external devices. The external device could be separate devices, such as other computing devices, wireless access points or base stations, as well as peripherals such as headsets, printers, or other devices. In one example, device 10000 exchanges data with an external device for storage in memory or for display on a display device. The exchanged data can include data to be stored in memory, or data already stored in memory, to read, write, or edit data.

Connectivity 1070 can include multiple different types of connectivity. To generalize, device 1000 is illustrated with cellular connectivity 1072 and wireless connectivity 1074. Cellular connectivity 1072 refers generally to cellular network connectivity provided by wireless carriers, such as provided via GSM (global system for mobile communications) or variations or derivatives, CDMA (code division multiple access) or variations or derivatives, TDM (time division multiplexing) or variations or derivatives, LTE (long term evolution—also referred to as “4G”), or other cellular service standards. Wireless connectivity 1074 refers to wireless connectivity that is not cellular and can include personal area networks (such as Bluetooth), local area networks (such as WiFi), or wide area networks (such as WiMax), or other wireless communication, or a combination. Wireless communication refers to transfer of data through the use of modulated electromagnetic radiation through a non-solid medium. Wired communication occurs through a solid communication medium.

Peripheral connections 1080 include hardware interfaces and connectors, as well as software components (e.g., drivers, protocol stacks) to make peripheral connections. It will be understood that device 1000 could both be a peripheral device (“to” 1082) to other computing devices, as well as have peripheral devices (“from” 1084) connected to it. Device 1000 commonly has a “docking” connector to connect to other computing devices for purposes such as managing (e.g., downloading, uploading, changing, synchronizing) content on device 1000. Additionally, a docking connector can allow device 1000 to connect to certain peripherals that allow device 1000 to control content output, for example, to audiovisual or other systems.

In addition to a proprietary docking connector or other proprietary connection hardware, device 1000 can make peripheral connections 1080 via common or standards-based connectors. Common types can include a Universal Serial Bus (USB) connector (which can include any of a number of different hardware interfaces), DisplayPort including MiniDisplayPort (MDP), High Definition Multimedia Interface (HDMI), Firewire, or other type.

In one example, memory controller 1064 of memory subsystem 1060 includes ECC circuitry 1063 and scrub circuitry 1065 to implement memory scrubbing operations associated with one or more RAS features. These memory scrubbing operations may be in accordance with any example described herein.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” and may be similar to IP blocks. IP cores may be stored on a tangible, machine readable medium and supplied to various customers or manufacturing facilities to load into the fabrication machines that actually make the logic or processor.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some examples may include an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

Some examples may be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled” or “coupled with”, however, may also mean that two or more elements are not in direct contact with each other, but yet still co-operate or interact with each other.

To the extent various operations or functions are described herein, they can be described or defined as software code, instructions, configuration, and/or data. The content can be directly executable (“object” or “executable” form), source code, or difference code (“delta” or “patch” code). The software content of what is described herein can be provided via an article of manufacture with the content stored thereon, or via a method of operating a communication interface to send data via the communication interface. A machine readable storage medium can cause a machine to perform the functions or operations described and includes any mechanism that stores information in a form accessible by a machine (e.g., computing device, electronic system, etc.), such as recordable/non-recordable media (e.g., read only memory (ROM), random access memory (RAM), magnetic disk storage media, optical storage media, flash memory devices, etc.). A communication interface includes any mechanism that interfaces to any of a hardwired, wireless, optical, etc., medium to communicate to another device, such as a memory bus interface, a processor bus interface, an Internet connection, a disk controller, etc. The communication interface can be configured by providing configuration parameters and/or sending signals to prepare the communication interface to provide a data signal describing the software content. The communication interface can be accessed via one or more commands or signals sent to the communication interface.

The follow examples pertain to additional examples of technologies disclosed herein.

Example 1. An example memory controller can include first circuitry configured to correct errors detected in ECC encoded data and second circuitry. The second circuitry can be configured to send a scrub read request to a memory device to obtain ECC encoded data stored in a physical memory unit maintained at the memory device. The second circuitry can also detect at least one error in the ECC encoded data. The second circuitry can also notify the first circuitry of the at least one error in the ECC encoded data to cause the first circuitry to correct the at least one error in the ECC encoded data to generate scrubbed ECC encoded data. The second circuitry can also send a scrub write request to the memory device to cause the scrubbed ECC encoded data to be stored in the physical memory unit maintained at the memory device. The second circuitry can also send a second scrub read request to the memory device to obtain the scrubbed ECC encoded data stored in the physical memory unit, The second circuitry can also detect at least one error in the scrubbed ECC encoded data. The second circuitry can also trigger one or more RAS features that includes removal of the physical memory unit from a system memory map and a remap of system memory addresses previously associated with the physical memory unit to a second physical memory unit.

Example 2. The memory controller of example 1, the second physical memory unit can be maintained at the memory device. For this example, the second circuitry can be further configured to notify the first circuitry of the at least one error in the scrubbed ECC encoded data to cause the first circuitry to correct the at least one error in the ECC encoded data to generate corrected scrubbed ECC encoded data. The second circuitry can also send a second scrub write request to the memory device to cause the corrected scrubbed ECC encoded data to be stored in the second physical memory unit.

Example 3. The memory controller of example 1, the second physical memory unit can be maintained at a second memory device. For this example the second circuitry can be further configured to notify the first circuitry of the at least one error in the scrubbed ECC encoded data to cause the first circuitry to correct the at least one error in the ECC encoded data to generate corrected scrubbed ECC encoded data. The second circuitry can also send a second scrub write request to second memory device to cause the corrected scrubbed ECC encoded data to be stored in the second physical memory unit.

Example 4. The memory controller of example 1, the RAS feature can be an sPPR process or an hPPR process.

Example 5. The memory controller of example 4, the second circuitry can also cause a resilvering process to be implemented following the sPPR or the hPPR process that can result in all ECC encoded data stored in the physical memory unit to be stored in the second physical memory unit.

Example 6. The memory controller of example 1, the scrub read request to obtain the ECC encoded data stored in the physical memory unit maintained at the memory device can be responsive to a patrol memory scrubbing operation.

Example 7. The memory controller of example 1, the memory device can be a DIMM that includes SDRAM. For this example, the physical memory unit and the second physical memory unit can be separate banks of the SDRAM.

Example 8. An example method can include sending, at a memory controller coupled with a memory device, a scrub read request to obtain ECC encoded data stored in a physical memory unit maintained at the memory device. The method can also include detecting at least one error in the ECC encoded data. The method can also include correcting the at least one error in the ECC encoded data to generate scrubbed ECC encoded data. The method can also include sending a scrub write request to the memory device to cause the scrubbed ECC encoded data to be stored in the physical memory unit maintained at the memory device. The method can also include sending a second scrub read request to the memory device to obtain the scrubbed ECC encoded data stored in the physical memory unit. The method can also include detecting at least one error in the scrubbed ECC encoded data. The method can also include triggering one or more RAS features that includes removal of the physical memory unit from a system memory map and a remap of system memory addresses previously associated with the physical memory unit to a second physical memory unit.

Example 9. The method of example 8, the second physical memory unit can be maintained at the memory device. For this example the method can also include correcting the at least one error in the scrubbed ECC encoded data. The method can also include sending a second scrub write request to the memory device to cause the corrected scrubbed ECC encoded data to be stored in the second physical memory unit.

Example 10. The method of example 8, the second physical memory unit can be maintained at a second memory device. For this example, the method can also include correcting the at least one error in the scrubbed ECC encoded data. The method can also include sending a second scrub write request to second memory device to cause the corrected scrubbed ECC encoded data to be stored in the second physical memory unit.

Example 11. The method of example 8, the RAS feature can be an sPPR process or an hPPR process.

Example 12. The method of example 11 can also include implementing a resilvering process following the sPPR or hPPR process to cause all ECC encoded data stored in the physical memory unit to be stored in the second physical memory unit.

Example 13. The method of example 8, the scrub read request to obtain the ECC encoded data stored to in the physical memory unit maintained at the memory device can be responsive to a patrol memory scrubbing operation.

Example 14. The method of example 8, the memory device can be a DIMM that includes SDRAM. For this example, the physical memory unit and the second physical memory unit can be separate banks of the SDRAM.

Example 15. An example at least one machine readable medium can include a plurality of instructions that in response to being executed by a system can cause the system to carry out a method according to any one of examples 8 to 14.

Example 16. An example apparatus can include means for performing the methods of any one of examples 8 to 14.

Example 17. At least one machine readable medium can include a plurality of instructions that in response to being executed by circuitry of a memory controller coupled with a memory device can cause the circuitry to send a scrub read request to obtain ECC encoded data stored in a physical memory unit maintained at the memory device. The instructions can also cause the circuitry to detect at least one error in the ECC encoded data. The instructions can also cause the circuitry to correct the at least one error in the ECC encoded data to generate scrubbed ECC encoded data. The instructions can also cause the circuitry to send a scrub write request to the memory device to cause the scrubbed ECC encoded data to be stored in the physical memory unit maintained at the memory device. The instructions can also cause the circuitry to send a second scrub read request to the memory device to obtain the scrubbed ECC encoded data stored in the physical memory unit. The instructions can also cause the circuitry to detect at least one error in the scrubbed ECC encoded data. The instructions can also cause the circuitry to trigger one or more RAS features that includes removal of the physical memory unit from a system memory map and a remap of system memory addresses previously associated with the physical memory unit to a second physical memory unit.

Example 18. The at least one machine readable medium of example 17, the second physical memory unit can be maintained at the memory device. For this example, the instructions can further cause the circuitry to correct the at least one error in the scrubbed ECC encoded data. The instructions can also cause the circuitry to send a second scrub write request to the memory device to cause the corrected scrubbed ECC encoded data to be stored in the second physical memory unit.

Example 19. The at least one machine readable medium of example 17, the second physical memory unit is maintained at second memory device. For this example, the instructions can further cause the circuitry to correct the at least one error in the scrubbed ECC encoded data. The instructions can also cause the circuitry to send a second scrub write request to second memory device to cause the corrected scrubbed ECC encoded data to be stored in the second physical memory unit.

Example 20. The at least one machine readable medium of example 17, the RAS feature can be an sPPR process or an hPPR process.

Example 21. The at least one machine readable medium of example 20, the instructions can also cause the circuitry to implement a resilvering process following the sPPR or hPPR process to cause all ECC encoded data stored in the physical memory unit to be stored in the second physical memory unit.

Example 22. The at least one machine readable medium of example 17, the scrub read request to obtain the ECC encoded data stored to in the physical memory unit maintained at the memory device can be responsive to a patrol memory scrubbing operation.

Example 23. The at least one machine readable medium of example 17, the memory device can be a DIMM that includes SDRAM. For this example, the physical memory unit and the second physical memory unit can be separate banks of the SDRAM.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A memory controller comprising:
first circuitry configured to correct errors detected in ECC encoded data; and
second circuitry configured to:
send a scrub read request to a memory device to obtain ECC encoded data stored in a physical memory unit maintained at the memory device;
detect at least one error in the ECC encoded data;
notify the first circuitry of the at least one error in the ECC encoded data to cause the first circuitry to correct the at least one error in the ECC encoded data to generate scrubbed ECC encoded data;
send a scrub write request to the memory device to cause the scrubbed ECC encoded data to be stored in the physical memory unit maintained at the memory device;
send a second scrub read request to the memory device to obtain the scrubbed ECC encoded data stored in the physical memory unit;
detect at least one error in the scrubbed ECC encoded data; and
trigger one or more reliability, availability, and serviceability (RAS) features that includes removal of the physical memory unit from a system memory map and a remap of system memory addresses previously associated with the physical memory unit to a second physical memory unit.

2. The memory controller of claim 1, wherein the second physical memory unit is maintained at the memory device, the second circuitry further configured to:
notify the first circuitry of the at least one error in the scrubbed ECC encoded data to cause the first circuitry to correct the at least one error in the ECC encoded data to generate corrected scrubbed ECC encoded data; and
send a second scrub write request to the memory device to cause the corrected scrubbed ECC encoded data to be stored in the second physical memory unit.

3. The memory controller of claim 1, wherein the second physical memory unit is maintained at a second memory device, the second circuitry further configured to:
notify the first circuitry of the at least one error in the scrubbed ECC encoded data to cause the first circuitry to correct the at least one error in the ECC encoded data to generate corrected scrubbed ECC encoded data; and
send a second scrub write request to second memory device to cause the corrected scrubbed ECC encoded data to be stored in the second physical memory unit.

4. The memory controller of claim 1, wherein the RAS feature comprises a soft post package repair (sPPR) process or a hard post package repair (hPPR) process.

5. The memory controller of claim 4, further comprising the second circuitry to:
cause a resilvering process to be implemented following the sPPR or the hPPR process that results in all ECC encoded data stored in the physical memory unit to be stored in the second physical memory unit.

6. The memory controller of claim 1, wherein the scrub read request to obtain the ECC encoded data stored in the physical memory unit maintained at the memory device is responsive to a patrol memory scrubbing operation.

7. The memory controller of claim 1, the memory device comprises a dual in-line memory module (DIMM) that includes synchronous dynamic random access memory (SDRAM), wherein the physical memory unit and the second physical memory unit are separate banks of the SDRAM.

8. A method comprising:
sending, at a memory controller coupled with a memory device, a scrub read request to obtain error correction code (ECC) encoded data stored in a physical memory unit maintained at the memory device;
detecting at least one error in the ECC encoded data;
correcting the at least one error in the ECC encoded data to generate scrubbed ECC encoded data;
sending a scrub write request to the memory device to cause the scrubbed ECC encoded data to be stored in the physical memory unit maintained at the memory device;
sending a second scrub read request to the memory device to obtain the scrubbed ECC encoded data stored in the physical memory unit;
detecting at least one error in the scrubbed ECC encoded data; and
triggering one or more reliability, availability, and serviceability (RAS) features that includes removal of the physical memory unit from a system memory map and a remap of system memory addresses previously associated with the physical memory unit to a second physical memory unit.

9. The method of claim 8, wherein the second physical memory unit is maintained at the memory device, the method further comprising:
correcting the at least one error in the scrubbed ECC encoded data; and
sending a second scrub write request to the memory device to cause the corrected scrubbed ECC encoded data to be stored in the second physical memory unit.

10. The method of claim 8, wherein the second physical memory unit is maintained at a second memory device, the method further comprising:
correcting the at least one error in the scrubbed ECC encoded data; and
sending a second scrub write request to second memory device to cause the corrected scrubbed ECC encoded data to be stored in the second physical memory unit.

11. The method of claim 8, wherein the RAS feature comprises a soft post package repair (sPPR) process or a hard post package repair (hPPR) process.

12. The method of claim 11, further comprising:
implementing a resilvering process following the sPPR or the hPPR process to cause all ECC encoded data stored in the physical memory unit to be stored in the second physical memory unit.

13. The method of claim 8, wherein the scrub read request to obtain the ECC encoded data stored to in the physical memory unit maintained at the memory device is responsive to a patrol memory scrubbing operation.

14. The method of claim 8, the memory device comprises a dual in-line memory module (DIMM) that includes synchronous dynamic random access memory (SDRAM), wherein the physical memory unit and the second physical memory unit are separate banks of the SDRAM.

15. At least one machine readable medium comprising a plurality of instructions that in response to being executed by circuitry of a memory controller coupled with a memory device cause the circuitry to:
send a scrub read request to obtain error correction code (ECC) encoded data stored in a physical memory unit maintained at the memory device;
detect at least one error in the ECC encoded data;
correct the at least one error in the ECC encoded data to generate scrubbed ECC encoded data;
send a scrub write request to the memory device to cause the scrubbed ECC encoded data to be stored in the physical memory unit maintained at the memory device;
send a second scrub read request to the memory device to obtain the scrubbed ECC encoded data stored in the physical memory unit;
detect at least one error in the scrubbed ECC encoded data; and
trigger one or more reliability, availability, and serviceability (RAS) features that includes removal of the physical memory unit from a system memory map and a remap of system memory addresses previously associated with the physical memory unit to a second physical memory unit.

16. The at least one machine readable medium of claim 15, wherein the second physical memory unit is maintained at the memory device, the instructions to further cause the circuitry to:
correct the at least one error in the scrubbed ECC encoded data; and
send a second scrub write request to the memory device to cause the corrected scrubbed ECC encoded data to be stored in the second physical memory unit.

17. The at least one machine readable medium of claim 15, wherein the second physical memory unit is maintained at a second memory device, the instructions to further cause the circuitry to:
correct the at least one error in the scrubbed ECC encoded data; and
send a second scrub write request to second memory device to cause the corrected scrubbed ECC encoded data to be stored in the second physical memory unit.

18. The at least one machine readable medium of claim 15, wherein the RAS feature comprises a soft post package repair (sPPR) process or a hard post package repair (hPPR) process.

19. The at least one machine readable medium of claim 18, further comprising the instructions to cause the circuitry to:
implement a resilvering process following the sPPR or the hPPR process to cause all ECC encoded data stored in the physical memory unit to be stored in the second physical memory unit.

20. The at least one machine readable medium of claim 15, wherein the scrub read request to obtain the ECC encoded data stored to in the physical memory unit maintained at the memory device is responsive to a patrol memory scrubbing operation.
